(19) United States
(12) Patent Application Publication
(10) Pub. No.: US 2022/0017366 A1
(43) Pub. Date: Jan. 20, 2022

(54) PROCESS FOR PRODUCING PHOSPHORUS

(71) Applicants: Universite Mohammed VI Polytechnique, Ben Guerir (MA); Universite Hassan 1ER De Settat, Settat (MA); Universite Hassan II De Casablanca, Casablanca (MA)

(72) Inventors: Younes Alami Hamedane, Casablanca (MA); Hassan Hannache, Casablanca (MA); Bouchaib Manoun, Settat (MA); Youssef Tamraoui, Settat (MA); Mina Oumam, Mohammedia (MA); Said Gmouh, Sale (MA)

(21) Appl. No.: 17/311,324

(22) PCT Filed: Dec. 4, 2019
(86) PCT No.: PCT/MA2019/050003

§ 371 Date: Jun. 5, 2021

(51) Int. Cl. C01B 25/023

(52) U.S. Cl. CPC C01B 25/023

(57) ABSTRACT

The subject of the invention is the development of a new process for producing phosphorus P4 from phosphoric acid. In this process, the phosphoric acid and a hydrophilic source of carbon and of hydrogen (biomass, kerogen, “STEP” purification plant sludge, organic polymer) are mixed, and the mixture is treated at a temperature of 80 to 150° C. in order to ensure grafting of the phosphates on the carbon backbone. The production of the phosphorus P4 is carried out by heat treatment of the precursor at a temperature at which phosphorus is produced. The temperature range is from 550° C. to 950° C. This process can be carried out at temperatures below those of conventional phosphorus production without the occurrence of the production of solid by-products normally formed in conventional phosphorus production. The process can be used to produce phosphoric acid for food or medical use.

### FIELD OF THE INVENTION

The present invention relates to the field of production of elemental phosphorus. It relates in particular to a process for the synthesis of red and or white phosphorus by reduction of phosphoric acid.

### STATE OF THE PRIOR ART

Elemental phosphorus mainly comes in three forms: black, red and white phosphorus.

Elemental phosphorus is mainly found in the form of red phosphorus because white phosphorus turns under the action of light and heat into red phosphorus.

Phosphorus pentoxide (P2O5), is also interesting as it is the unit that is widely used by agronomists and analytical laboratories to express the measurement result of phosphorus in soil. It is formed when phosphorus burns in air and it reacts very violently with water to give phosphoric acid.

In the industrial field, organophosphates arouse interest and enter into the formulation of common products, along others, cleaning products, pharmaceuticals and fertilizers.

The applications of phosphorus are numerous. In the form of acid salts, they are found as components in the formulation of detergents and in products for the treatment of water boilers in order to avoid scaling problems.

Several works have described processes for producing phosphorus:

It is obtained by hydrothermal treatment of biomass [1]. In this context, biomass-based feeds are treated under hydrothermal treatment conditions to produce a liquid hydrocarbon product and a solid part. The solid part may contain part of the phosphorus from the biomass feed. The amount of phosphorus in the solid can increase for some biomass feeds by adding a multivalent metal to the feed. The method of hydrothermal treatment of biomass, consists in introducing a biomass feed having, a water/biomass ratio of at least 1:1 in a reaction zone to produce a multi-phase product, comprising a part of solids containing about 80% of the phosphorus content of the biomass feed. The amount of phosphorus produced remains very low for this process.

One method of recovering phosphorus from organic sludge [2] consists of producing incinerated ash from organic sludge, The recovery of phosphorus is achieved by contacting the vaporized phosphorus with water to condense the phosphorus. The vaporized phosphorus is oxidized to phosphorus pentoxide and the phosphorus is recovered as phosphoric acid by contacting the phosphorus pentoxide with water. This process is expensive since it requires incineration of the sludge containing a lot of water and the phosphorus yield is relatively low.

The production of phosphorus by reacting a mixture comprising calcium phosphate, quartz sand and coke. The reaction is carried out between 1 *** 300° C. and 1700° C. by electric heating in an autogenous fluidized coke bed [3]. Coke is used in particles having a size of 0.1 to 5 mm, and each of the components of calcium phosphate, quartz sand and coke forming the mixture is used in particles having a size of 0.01 to 5 mm. The reduction furnace used in the implementation of this process consists of a carbon furnace vessel provided with at least one movable electrode projecting from above, a refractory heat insulation encapsulating the vessel, at least a raw material inlet, outlet for discharging the furnace gas containing phosphorus and carbon monoxide. This process is very energy intensive.

The production of phosphorus P4 by heating a mixture of phosphoric acid and a particular carbon-based reducing agent (pyrolytic) with a specific surface area greater than 50 m2/g, with microwave radiation in a non-oxidizing atmosphere has was carried out in 2001 [4]. This process requires the use of a high added value micronized reducing agent. However, the cost of the pyrolytic reducing agent and the type of heating remain high.

### SUMMARY OF THE INVENTION

The object of the invention is the development of a new process for producing phosphorus P4 from crude or purified phosphoric acid.

In this process, phosphoric acid is mixed with a hydrophilic source of carbon and hydrogen (biomass, kerogen, sludge from wastewater treatment plants “WWTPs”, organic polymer), the mixture is treated at a temperature of 80 to 150° C. to ensure the grafting of phosphates on the carbon skeleton. The production of phosphorus P4 is carried out by heat treatment of the precursor at a temperature at which the phosphorus is produced. The temperature range is 550° C. to 950° C. This process can be carried out at temperatures lower than those of conventional phosphorus production without taking place in the production of solid by-products normally formed in conventional phosphorus production. As an application, pure phosphoric acid can be produced for food or medical use.

### DESCRIPTION OF DRAWINGS

FIG. 1: Illustration of the grafting of phosphate ions onto the carbon skeleton via the formation of POC bridges after impregnation of the hydrophilic support With the phosphoric acid solution.

FIG. 2: Diagram of the pyrolizer.

FIG. 3: X-ray fluorescence analysis.

FIG. 4: Raman spectrum of white phosphorus P4.

FIG. 5: Illustration of the analysis of thermograms showing the dependence of the residue level on the amount of phosphoric acid impregnated in the biomass.

FIG. 6: Decrease in the residue rate as a function of temperature.

FIG. 7: Rate of conversion of phosphorus to the gaseous state.

FIG. 8: Evolution of the product of the percentage of phosphorous by the rate of the residue.

### DESCRIPTION OF THE INVENTION

The object of the present invention is to implement a new process for the production of S phosphorus from phosphoric acid. To do this, the invention aims to develop an efficient process for obtaining elemental phosphorus by reduction of the phosphate ion in the presence of a hydrophilic source of carbon and hydrogen temperatures not exceeding 950° C.

The production phosphorus P4 is established in three stages:

1. Preparation of the mixture: phosphoric acid is mixed with a hydrophilic source of carbon and hydrogen, preferably cellulose biomass, kerogen, sludge from WWTPs, etc.).
2. Treatment of the fixture: the mixture is treated at a temperature ranging from 80 to 150° C., to ensure the grafting of the phosphates on the carbon skeleton.
3. Pyrolysis of the precursor: the precursor is heat treated, in a furnace with conventional fixed, rotary or fluidized bed heating, in a totally or partially inert medium at a temperature between 550 and 950° C.

### EXAMPLE

The following example is presented to describe the manufacturing process for phosphorus P4. However, the example should not be interpreted as limiting the manufacturing process developed.

### Preparation of the Precursor

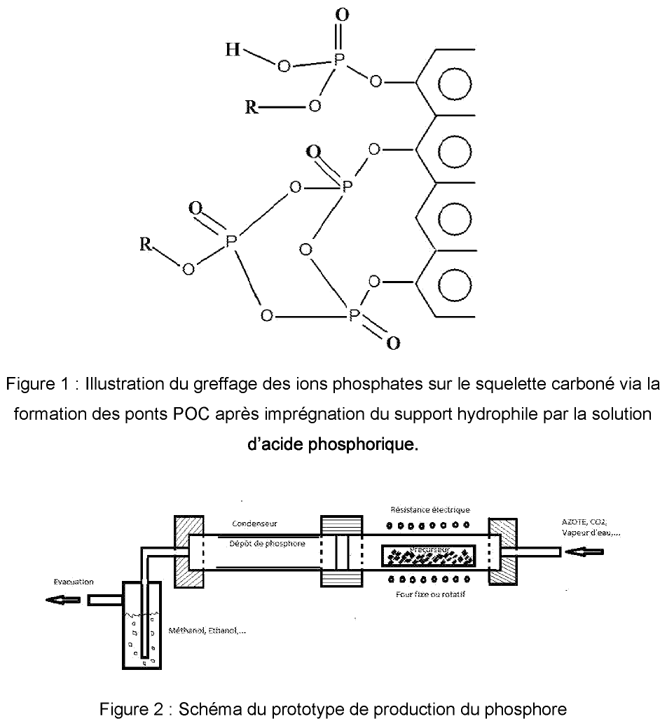

Different sources of carbon, in particular of plant biomass (olive pomace, coffee grounds, pomegranate bark, sawdust, etc.) were tested for different mass ratios of the mixture of phosphoric acid/hydrophilic carbon source and hydrogen. The mixture was heat treated to ensure the grafting of the phosphates on the carbon skeleton. In fact, under the effect of temperature, water evaporates and thus allows the formation of organo-phosphate compounds. The grafting of the phosphate ions unto the carbon skeleton is ensured by the formation of POC bridges after impregnation of the hydrophilic support with the phosphoric acid solution (FIG. 1 below).

### Pyrolysis of the Precursor

This step consists of a heat treatment of the precursor, in a furnace with conventional fixed heating, rotary or fluidized bed, in a tubular pyrolizer (FIG. 2).

The gaseous phosphorus formed is transported to the cold zone and condenses on the walls of the reactor. The non-condensed phosphorus is bubbled through methanol (or ethanol) and dissolves in the latter. Only the carbon dioxide is evacuated to an extractor and can be recovered and stored for possible use.

At the end of the reaction, the solid phosphorus produced can be recovered in solid form (taking the necessary precautions) or dissolved in an organic solvent, preferably an oil or an alcohol.

Organic solutions containing phosphorus can be used as a raw material for the synthesis of phosphorus compounds. White or red phosphorus has various applications in the synthesis of phosphorus-based materials. Another application is in the production of high purity phosphoric acid.

The process is characterized by an almost total recovery of the raw material used and generates a limited quantity of by-products.

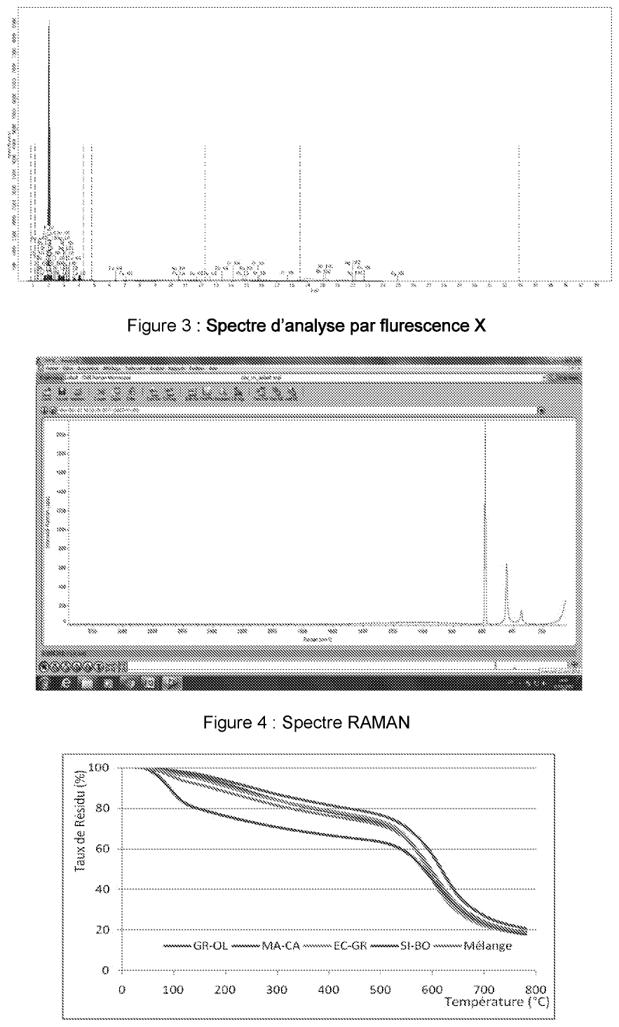

Fluorescence analysis (FIG. 3) clearly showed that the material contains more than 97% phosphorus. To determine the nature of the phosphorus obtained, a study by Raman spectroscopy was carried out.

The Raman spectrum of the material (FIG. 4) shows 3 fine modes which correspond exactly to white phosphorus P4. Indeed, a comparison was made with the Raman spectrum of P4 carried out in the 1930s [5, 6]. The most intense, polarized mode corresponds to the breathing mode of the P4 tetrahedron.

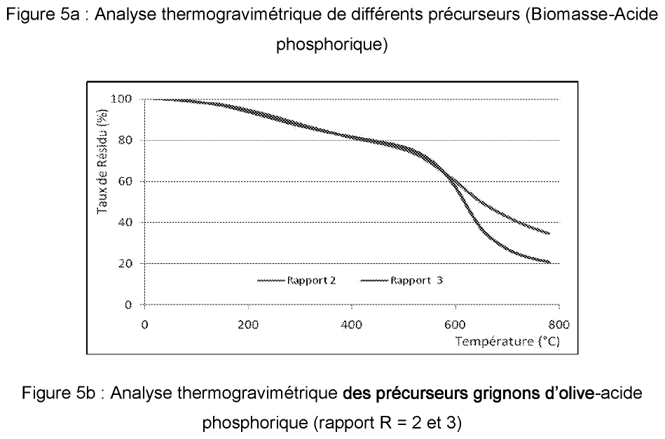

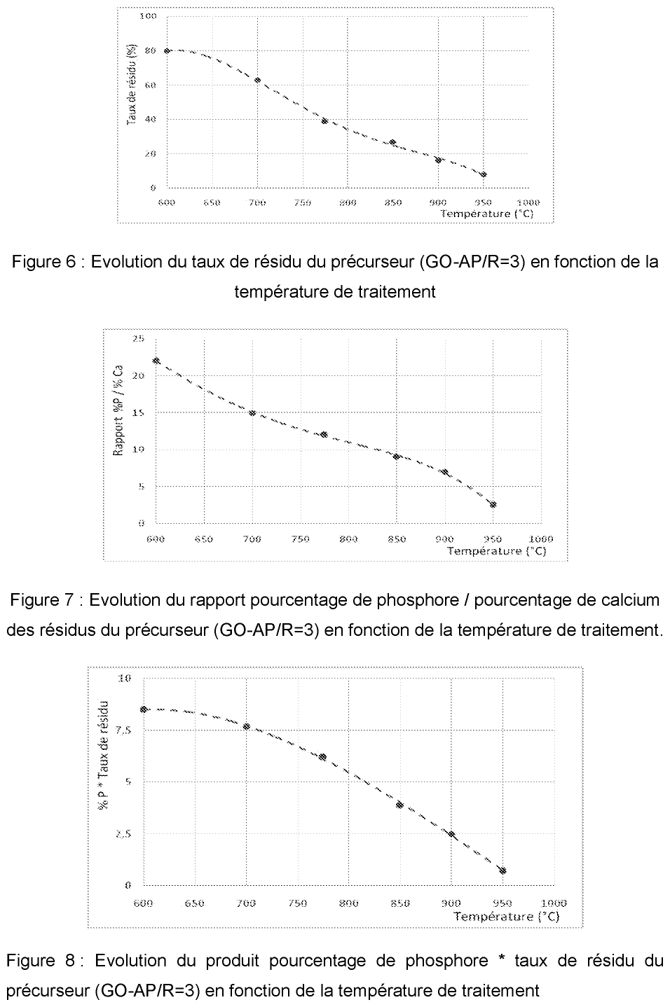

The thermogravimetric analysis of the various samples in an inert medium shows that all the samples have the same appearance on the thermograms, regardless of the precursors used (FIG. 5). However, the residue levels depend greatly on the quantities of phosphoric acids introduced during the preparation of the precursors (FIG. 6).

By comparing the thermograms (FIG. 5) with the observations made during the pyrolysis of the precursor, it can be noted that around a temperature of 550° C., a mist of vapors appears; a gas which begins to form in the tube at the exit of the furnace (at the level of the condenser). The flow rate of these vapors increases with the increase in pyrolysis temperature as well as with the rate of heating of the furnace. The gas cools and condenses in a tubular exchanger, placed just at the outlet of the pyrolvzer. A trapping system makes it possible to recover the product of the reaction P4 in its solid form, deposited on the walls of the tubes.

Analysis of the thermograms (FIG. 6) shows that the residue level depends on the amount of phosphoric acid impregnated in the biomass. At around 750° C., the amount of P4 generated with ratio 3 is greater than that generated with ratio 2. FIG. 6 shows that the residue level decreases with increasing temperature. It reaches a value of 8% at 950° C.

Knowing that the amount of calcium in the precursor remains co stain during the heat treatment, monitoring the change in the ratio of the percentage of phosphorus to the, percentage of calcium will give a precise idea of the amount of phosphorus transformed. FIG. 7 shows that the ratio of the percentages of compositions goes from 22 (T=600° C.) to 2.4 (950+ C.). which shows that practically all of the phosphorus passes to the gaseous state.

The evolution of the product of the percentage of phosphorus by the rate of residue, P*TR (FIG. 8) confirms the previous findings and clearly shows that the amount of residual phosphorus at 950° C. is very low.

### INDUSTRIAL APPLICATION

The reaction can be carried out at a much lower temperature than that by the conventional method, thus producing a great saving of energy. As an application we can consider the production of pure phosphoric acid for food or medical use.

### BIBLIOGRAPHICAL REFERENCES

1—Phosphorus recovery from hydrothermal treatment of biomass; US008624070B2
2—Process for recovering phosphorus from organic sludge; US006022514A.
3—Processes and equipment for production of elemental phosphorus and thermal phosphoric acid; US004919906
4—Method of preparing phosphorus; US006207024B1
5—S. Bhagantam, Ind. Phys. day 5 73 (1910)
6—C. s. Venkateswaran, proc. Ind. Acad sci. 2260 (1935).

1. Process for preparing elemental phosphorus from phosphoric acid,
characterized in that the process is carried out in four steps described below:
Step 1: making a mixture of phosphoric acid and a hydrophilic source of carbon and hydrogen
Step 2: preparation of the precursor by heat treatment of the mixture obtained in step 1 at a temperature ranging from 80 to 150° C.
Step 3: heat treatment of the precursor in an inert or partially inert atmosphere at a temperature ranging from 550° C. to 950° C.
Step 4: Phosphorus recovery.

2. Method according to claim 1, characterized in that the carbon source is selected among plant biomass, fossil resources such as oil shale, fuel oil, heavy hydrocarbons or any residual organic matter such as spent activated carbon, ion exchange resins and WWTP sludge.

3. Method according to claim 1, characterized in that e heat treatment of the precursor produces phosphorus in the gaseous state from 550° C.

4. Method according to claim 3, characterized in that the gas formed rs recovered by condensation in the form of white phosphorus P4.

5. Method according to claim 3, characterized in that the gas formed is recovered by condensation in the form of red phosphorus.

6. Method according to claim 3, characterized in that the gas formed is dissolved either in a solvent or an organic oil or dissolved in a mineral oil.
